(19) United States
(12) Patent Application Publication
(10) Pub. No.: US 2018/0114082 A1
(43) Pub. Date: Apr. 26, 2018

(54) METHOD AND APPARATUS FOR SELECTING AN IMAGE

(71) Applicant: SAMSUNG SDS CO., LTD., Seoul (KR)

(72) Inventors: Jung Ah CHOI, Seoul (KR); Jin Ho CHOO, Seoul (KR); Jong Hang KIM, Seoul (KR); Jeong Seon YI, Seoul (KR); Ji Hoon KIM, Seoul (KR)

(73) Assignee: SAMSUNG SDS CO., LTD., Seoul (KR)

(21) Appl. No.: 15/791,981

(22) Filed: Oct. 24, 2017

(30) Foreign Application Priority Data
Oct. 24, 2016 (KR) 10-2016-0138633

(51) Int. Cl. G06K 9/03; G06K 9/20; G06K 9/46; G06T 7/20

(52) U.S. Cl. CPC G06K 9/036; G06K 9/2054; G06K 9/4642; H04N 19/51; G06K 2209/27; G06T 2207/30168; G06T 7/20

(57) ABSTRACT

A method for selecting an image for object recognition is provided. The method comprises receiving an image bitstream; acquiring predetermined first codec metadata information among codec metadata information from the received image bitstream; calculating a first quality measurement value using the acquired first codec metadata information; calculating a quality score of the image by using the calculated first quality measurement value; and selecting a predetermined number of images based on the calculated quality score of the image.

This application claims priority from Korean Patent Application No. 10-2016-0138633 filed on Oct. 24, 2016 in the Korean Intellectual Property Office, the disclosure of which is incorporated herein by reference in its entirety.

### BACKGROUND

### 1. Field of the Invention

The present invention relates to a method and an apparatus for selecting an image, and more particularly, to a method for selecting an image for selecting an image to be used for object recognition.

### 2. Description of the Related Art

When an object is detected or tracked from continuous images, a blurred image is generated when the motion of the object is large or an amount of light entering a camera sensor is insufficient. When the image is used in an object recognition apparatus as it is, accuracy of object recognition becomes very low.

In order to such a problem, provided is a technology that previously selects an image suitable for the object recognition among the continuous images and uses the selected image for the object recognition. As a result, the object recognition apparatus performs the object recognition for the image suitable for the object recognition to enhance the accuracy of the object recognition.

In order for the object recognition apparatus to use the selected image for the object recognition, quality measurement for selecting the image needs to be preceded. To this end, a quality measurement method using information of a spatial domain, such as an illumination change degree, sharpness, contrast, and the like of the image is provided.

However, the quality measurement method using the spatial domain information is disadvantageous in that the quality measurement for each item needs to be performed for each pixel of the image, so that complexity is very high. As a result, an image quality measurement technology that enhances the complexity is required.

### SUMMARY

A technical object of the present invention is to provide a method and an apparatus for measuring quality of an image using codec metadata information.

Particularly, a technical object is to provide a method and an apparatus for improving complexity of quality measurement by acquiring codec metadata information from a pre-encoded bitstream and measuring image quality using the acquired codec metadata information.

Another technical object of the present invention is to provide a method and an apparatus for extending a type of codec metadata information used for measuring quality of an image based on accuracy of object recognition.

Yet another technical object of the present invention is to provide a method and an apparatus capable of determining an image for using an object recognition result of an object recognition apparatus as feedback information to provide the object recognition result to the object recognition apparatus.

Still yet another technical object of the present invention is to provide a method and an apparatus for registering an image for an object recognition target as an object recognition reference image of an object recognition apparatus.

The technical objects of the present invention are not restricted to the aforementioned technical objects, and other objects of the present invention, which are not mentioned above, will become more apparent to one of ordinary skill in the art to which the present invention pertains by referencing the detailed description of the present invention given below.

The effects of the present invention are not limited to the aforementioned effects, and other objects, which are not mentioned above, will become more apparent to one of ordinary skill in the art to which the present invention pertains by referencing the detailed description of the present invention given below.

In some embodiments, a method for selecting an image for object recognition, the method comprising: receiving an image bitstream; acquiring predetermined first codec metadata information among codec metadata information from the received image bitstream; calculating a first quality measurement value using the acquired first codec metadata information; calculating a quality score of the image by using the calculated first quality measurement value; and selecting a predetermined number of images based on the calculated quality score of the image.

### BRIEF DESCRIPTION OF THE DRAWINGS

The above and other aspects and features of the present invention will become more apparent by describing in detail exemplary embodiments thereof with reference to the attached drawings, in which:

FIG. 1 is a configuration diagram of an object recognition system according to an exemplary embodiment of the present invention;

FIG. 2 is a hardware configuration diagram of an apparatus for selecting an image according to another exemplary embodiment of the present invention;

FIG. 3 is a flowchart of a method for selecting an image using one codec metadata according to yet another exemplary embodiment of the present invention;

FIG. 4 is a flowchart of a method for selecting an image using information on two codec metadata according to yet another exemplary embodiment of the present invention;

FIG. 5 is a flowchart of a method for selecting an image using a motion vector value with reference to some exemplary embodiments of the present invention;

FIG. 6 is a flowchart of a method for mapping a motion vector value with reference to some exemplary embodiments of the present invention;

FIG. 7 is an exemplary diagram for describing a process of calculating a quality measurement value using a motion vector value with reference to some exemplary embodiments of the present invention;

FIG. 8 is a flowchart of a method for selecting an image using a DCT coefficient value with reference to some exemplary embodiments of the present invention;

FIG. 9 is an exemplary diagram for describing a process of calculating a quality measurement value using a DCT coefficient value with reference to some exemplary embodiments of the present invention;

FIG. 10 is a flowchart of a method for selecting an image using a motion vector value and a DCT coefficient value as codec metadata information according to yet another exemplary embodiment of the present invention;

FIG. 11 is a flowchart of a method for measuring a quality of an image using spatial domain information according to still yet another exemplary embodiment of the present invention;

FIG. 12 is a flowchart of a method for selecting an image using feedback information acquired from an object recognition apparatus according to still yet another exemplary embodiment of the present invention; and

FIGS. 13A and 13B are examples for describing aspects of using feedback information of an apparatus for selecting an image with reference to some exemplary embodiments of the present invention.

### DETAILED DESCRIPTION OF THE EMBODIMENTS

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims Like reference numerals refer to like elements throughout the specification.

The terminology used herein is for the purpose of describing particular embodiments only and is not intended to be limiting of the invention. As used herein, the singular forms “a”, “an” and “the” are intended to include the plural forms as well, unless the context clearly indicates otherwise.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, the present invention will be described in more detail with reference to the accompanying drawings.

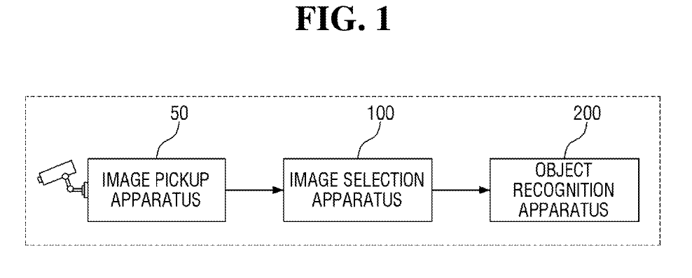

FIG. 1 is a configuration diagram of an object recognition system according to an exemplary embodiment of the present invention. Referring to FIG. 1, the object recognition system may include an image pickup apparatus 50, an image selection apparatus 100, and an object recognition apparatus 200. The image pickup apparatus 50, the image selection apparatus 100, and the object recognition apparatus 200 may be computing apparatuses capable of wired and/or wireless communication with each other.

The image pickup apparatus 50 may include a camera. The image pickup apparatus 50 may include an encoding unit and a communication unit for transmitting and receiving data. As a result, the image pickup apparatus 50 may acquire an image through the camera, compress the acquired image, and transmit the compressed image to the image selection apparatus 100.

According to the exemplary embodiment of the present invention, herein, the encoding unit may be a codec encoding unit. That is, the encoding unit may compress the acquired image using an encoding method according to a codec standard technique. The most commonly used codecs for image compression include Indeo, DivX, Xvid, H.264, WMV, RM, Cinepak, MOV, ASF, RA, XDM, RLE, and the like in addition to MPEG series (MPEG1, MPEG2, and MPEG4), but are not limited thereto.

The image pickup apparatus 50 may encode the image picked-up by the encoding unit and generate a bitstream in which the image is encoded. The image pickup apparatus 50 may transmit the created encoded bitstream to the image selection apparatus 100.

The image selection apparatus 100 may include a decoding unit and restore the image by decoding the received bitstream. Herein, the decoding unit may be used as a codec decoding unit. In the decoding process, the codec metadata information created when the image is encoded may be acquired from the bitstream.

The codec metadata information, as data obtained in the process of encoding the image, may include a motion vector value, a discrete cosine transform (DCT) coefficient value as a transform coefficient in a frequency domain, a block division size, a quantization parameter, a bit rate, and the like.

The image selection apparatus 100 may calculate a quality score of the image using the acquired codec metadata information and select an image to be transmitted to the object recognition apparatus 200 based on the calculated quality score. The image selection apparatus 100 may transmit the selected image to the recognition apparatus 200.

The object recognition apparatus 200 may perform object recognition using the received image. Further, the object recognition apparatus 200 performs the object recognition and may also transmit the result to the image selection apparatus 100 as feedback.

The object recognition apparatus 200 may be, for example, a face recognition apparatus. The face recognition apparatus may pre-register a reference image used for recognizing the face. The face recognition apparatus may perform face recognition by comparing a face image detected from the image input from the image selection apparatus 100 with the registered image.

According to another exemplary embodiment of the present invention, the image pickup apparatus 50, the image selection apparatus 100, and the object recognition apparatus 200 may be implemented by separate apparatuses as illustrated in FIG. 1, but the image pickup apparatus 50 and the image selection apparatus 100 may be implemented integrally with the object recognition apparatus 200.

In the latter case, the object recognition apparatus 200 may be implemented to include an image pickup unit for picking up the image and an encoding unit for encoding the corresponding image, and the image pickup unit and the encoding unit correspond to the image pickup apparatus 50. Further, the object recognition apparatus 200 may be implemented to include an image selection unit providing an image selection function and a decoding unit, and the image selection unit and the decoding unit correspond to the image selection unit 100.

According to yet another exemplary embodiment of the present invention, the image pickup apparatus 50 is installed outside and only the image selection apparatus 100 may also be implemented integrally with the object recognition apparatus 200.

Hereinafter, it will be assumed that the image pickup apparatus 50, the image selection apparatus 100, and the object recognition apparatus 200 are separately implemented, but it should be noted that each apparatus and an operation performed by each apparatus may be implemented to be integrated into one apparatus.

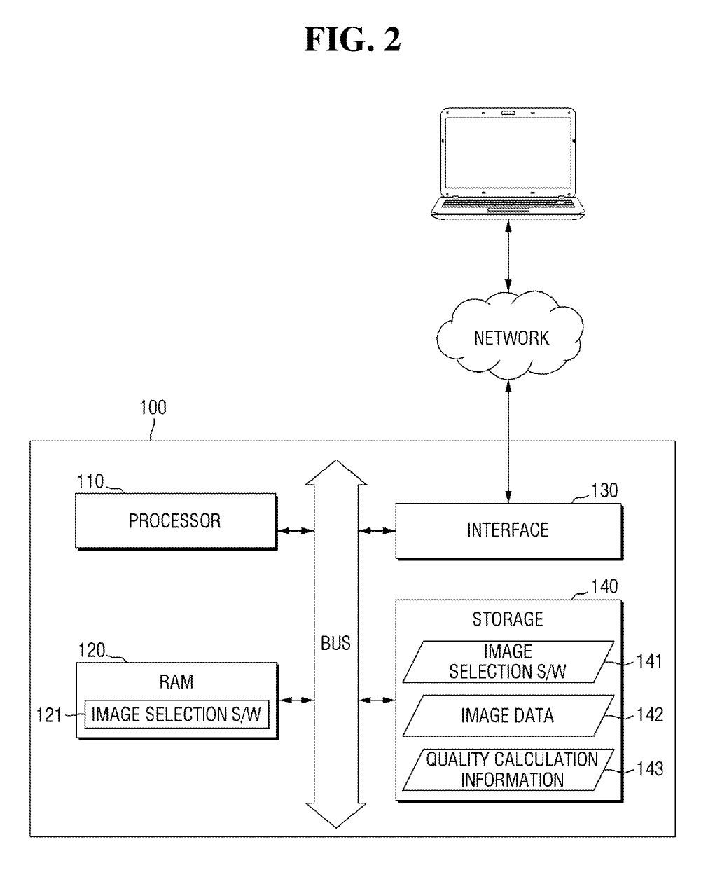

Hereinafter, a structure and an operation of the image selection apparatus 100 will be described with reference to FIG. 2. FIG. 2 is a hardware configuration diagram of the image selection apparatus 100 according to another exemplary embodiment of the present invention.

Referring to FIG. 2, the image selection apparatus 100 may include one or more processors 110, a memory 120 loading computer programs performed by the processors 110, a network interface 130 communicating with a plurality of apparatuses, and a storage 140 storing the computer programs.

The processor 110 controls the overall operation of each configuration of the image selection apparatus 100. The processor 110 may be configured to include a central processing unit (CPU), a micro processor unit (MPU), a micro controller unit (MCU), or any type of processor well-known in the art. Further, the processor 110 may perform an operation of at least application or program for executing the method according to the exemplary embodiments of the present invention. The image selection apparatus 100 may provide at least one processor.

The memory 120 stores various types of data, commands, and/or information. The memory 120 may load at least one program 121 from the storage 140 in order to execute the method for selecting the image according to the exemplary embodiments of the present invention. In FIG. 2, an RAM is illustrated as an example of the memory 120.

The network interface 130 supports wired/wireless Internet communication of the image selection apparatus 100. Further, the network interface 130 may also support various communication schemes in addition to the internet communication. To this end, the network interface 130 may be configured to include a communication module well-known in the art.

The network interface 130 may communicate with the image pickup apparatus 50 and the object recognition apparatus 200 illustrated in FIG. 1 via a network. Particularly, the network interface 130 may receive a bitstream of the encoded image from the image pickup apparatus 50 and receive feedback information including the object recognition result from the object recognition apparatus 200.

The storage 140 may non-temporarily store the at least one program 141, image data 142, and quality calculation information 143. In FIG. 2, as an example of the at least one program 141, an image selection software 141 is illustrated.

The storage 140 may be configured to include a nonvolatile memory such as a read only memory (ROM), an erasable programmable ROM (EPROM), an electrically erasable programmable ROM (EEPROM), a flash memory or the like, a hard disk, a removable disk, or any type of computer-readable recording medium well-known in the art to which the present invention pertains.

As the processor 110 executes the image selection software 141, the codec metadata information is acquired from the bitstream, and the quality measurement value may be calculated using specific codec metadata information. Further, according to the execution of the image selection software 141, the quality score of the image may be calculated based on the quality measurement value calculated using the calculated codec metadata information. Next, according to the execution of the image selection software 141, a predetermined number of images may be selected based on the calculated quality score of the image.

The image data 142 may include an image received from the image pickup apparatus 50 or a bitstream in which the image is encoded. Further, after the object recognition apparatus 200 performs the object recognition, when the image selection apparatus 100 receives feedback information therefor, the image selection apparatus 100 may transmit the image on the prestored image data 142 to the object recognition apparatus 200 based on the feedback information. Further, the image selection apparatus 100 may also modify quality calculation information 143 for the image on the prestored image data 142 based on the feedback information.

The quality calculation information 143 may include information required for calculating the quality score of the image. For example, the quality calculation information 143 may include information indicating on which metadata information a quality measurement value is calculated based among the codec metadata information or which weight is to be applied for each quality measurement value. Further, the quality calculation information 143 may also include information on the number of images to be transmitted to the image recognition apparatus 200.

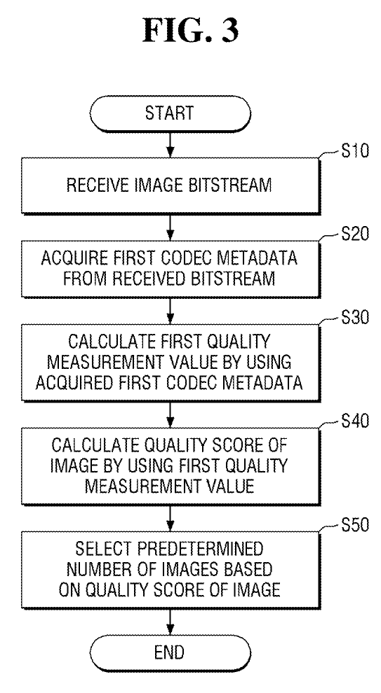

Hereinafter, a method for selecting an image according to yet another exemplary embodiment of the present invention will be described with reference to FIG. 3. It is assumed that the method for selecting the image is performed by the image selection apparatus 100. According to yet another exemplary embodiment of the present invention, the method for selecting the image may also be performed by the image selection unit implemented in the image recognition apparatus 200 as described above. FIG. 3 is a flowchart of a method for selecting an image using one piece of codec metadata information according to yet another exemplary embodiment of the present invention.

Referring to FIG. 3, the image selection apparatus 100 may receive an image bitstream acquired by encoding the image (S10) and acquire first codec metadata information from the received bitstream (S20). Herein, the first codec metadata information refers to one piece of metadata information predetermined as a criterion for quality measurement among the codec metadata information. The codec metadata information may include a motion vector value, a discrete cosine transform (DCT) coefficient value as a transform coefficient in a frequency domain, a block division size, a quantization parameter, and a bit rate. The image selection apparatus 100 may calculate a first quality measurement value using the acquired codec metadata information (S30).

The codec metadata includes a motion vector value, a discrete cosine transform (DCT) coefficient value as a transform coefficient in a frequency domain, a block division size, a quantization parameter, a bit rate, and the like, and the first codec metadata information may be set to any one among the sorted information.

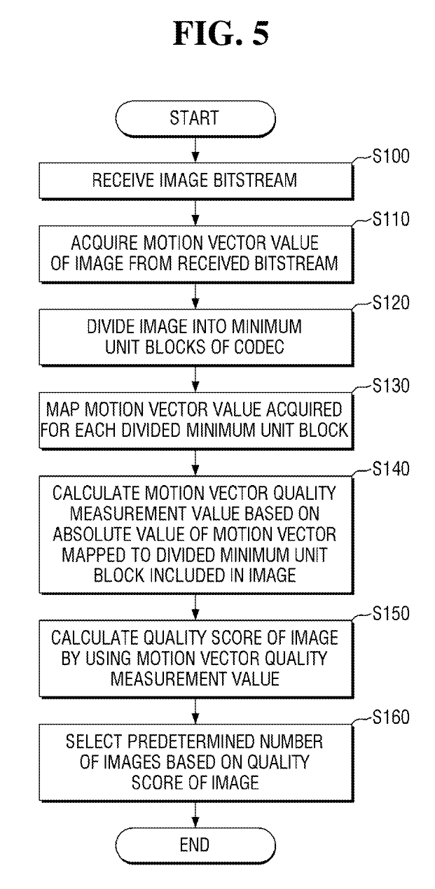

For example, when the first codec metadata information is set to the motion vector value, the image selection apparatus 100 may acquire the motion vector value from the bitstream. The image selection apparatus 100 may calculate a first quality measurement value for the motion vector value using the acquired motion vector value. The first codec metadata information which is set to the motion vector value will be described below in detail with reference to FIG. 5.

The image selection apparatus 100 may calculate the quality score of the image using the calculated first quality measurement value (S40) and select a predetermined number of images based on the calculated quality score (S50). If the predetermined number is two, the image selection apparatus 100 may select two images having the highest quality score and transmit the two images to the object recognition apparatus 200.

Meanwhile, in step S30, the first quality measurement value is calculated with respect to the entirety of the image and the image selection apparatus 100 may extract a partial region of interest (ROI) in an entire region of the image and calculate the quality measurement value with respect to only the ROI.

When the quality measurement is performed only with respect to the ROI, a region of which the quality is to be measured is reduced to improve a speed of the quality measurement and the quality measurement is performed with a focus on a part required for the object recognition to increase accuracy of the quality measurement and the object recognition.

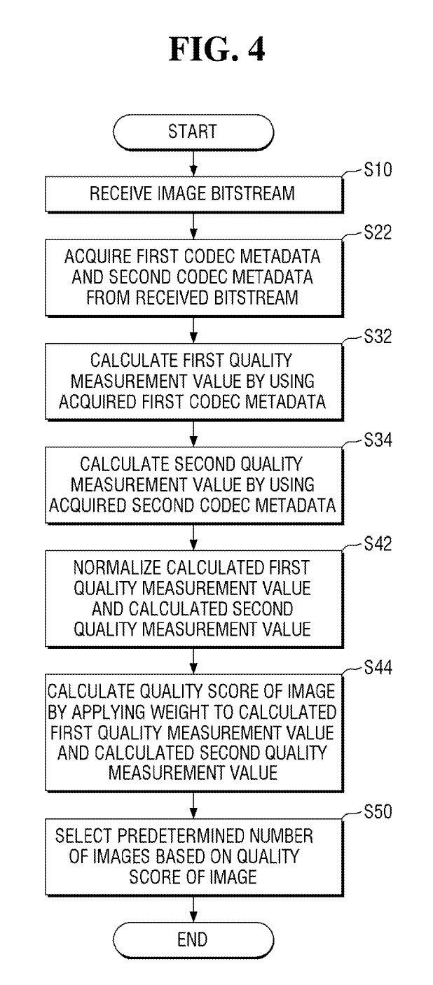

Meanwhile, the codec metadata information which becomes a criterion for the quality measurement may become two or more. Hereinafter, referring to FIG. 4, a method for selecting an image using two codec metadata information according to an exemplary embodiment of the present invention will be described. FIG. 4 is a flowchart of a method for selecting an image using information on two codec metadata according to yet another exemplary embodiment of the present invention.

The image selection apparatus 100 may receive an image bitstream (S10) and acquire the first codec metadata information and the second codec metadata information from the received bitstream (S22).

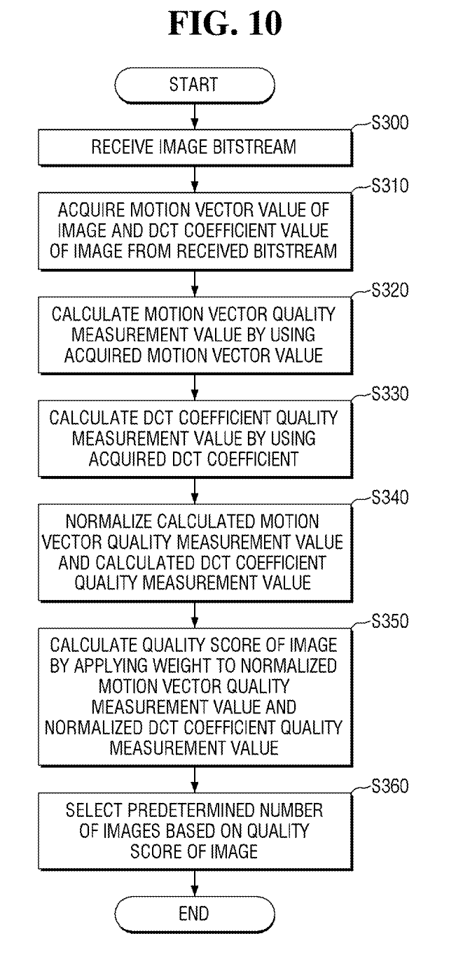

For example, when the first codec metadata information is set to a ‘motion vector value’ and the second codec metadata information is set to a ‘DCT coefficient value’, the image selection apparatus 100 may acquire the motion vector value and the DCT coefficient value from the bitstream. This case will be described in detail through FIG. 10.

When the image selection apparatus 100 acquires two codec metadata information, the image selection apparatus 100 may calculate the first quality measurement value by suing the acquired first codec metadata information (S32) and calculate the second quality measurement value by using the acquired second codec metadata information (S34).

The image selection apparatus 100 may perform normalization for the first quality measurement value and the second quality measurement value to uniformly reflect the first quality measurement value and the second quality measurement value on the quality score of the image (S42). For example, the first and second quality measurement values may be normalized so that a mean value of the first quality measurement value and the second quality measurement value becomes 0.

When the normalization is performed, the image selection apparatus 100 may calculate the quality score of the image by applying a predetermined weight to the normalized first and second quality measurement values (S44) and select a predetermined number of images based on the calculated quality score of the image (S50).

In step S44, the weight may be set according to importance of each codec metadata information. The weight may be an experimental value set by a user of the image selection apparatus 100 and a value automatically set by the image selection apparatus 100.

As one example, the image selection apparatus 100 analyzes the image acquired from the image pickup apparatus 50 to determine the importance of each code metadata information for the image based on the spatial domain information of the acquired image. According to the determination, the image selection apparatus 100 may automatically set the weight.

When the weight of the first codec metadata information is set to w₁ and the weight of the second codec metadata information is set to w₂, in the case where the first codec metadata information and the second codec metadata information have the same importance, the weights may be similarly set as w₁=w₂=0.5 and when an importance ratio of the first codec metadata information and the second codec metadata information is 7:3, the weight may be set as w₁=0.7, w₂=0.3.

As another example, the image selection apparatus 100 may automatically set the weight based on the feedback information for the object recognition result received from the object recognition apparatus 200.

As such, a case where influences which different codec metadata information exerts on the quality of the image may be considered and the accuracy of the object recognition may be increased by adjusting the weight.

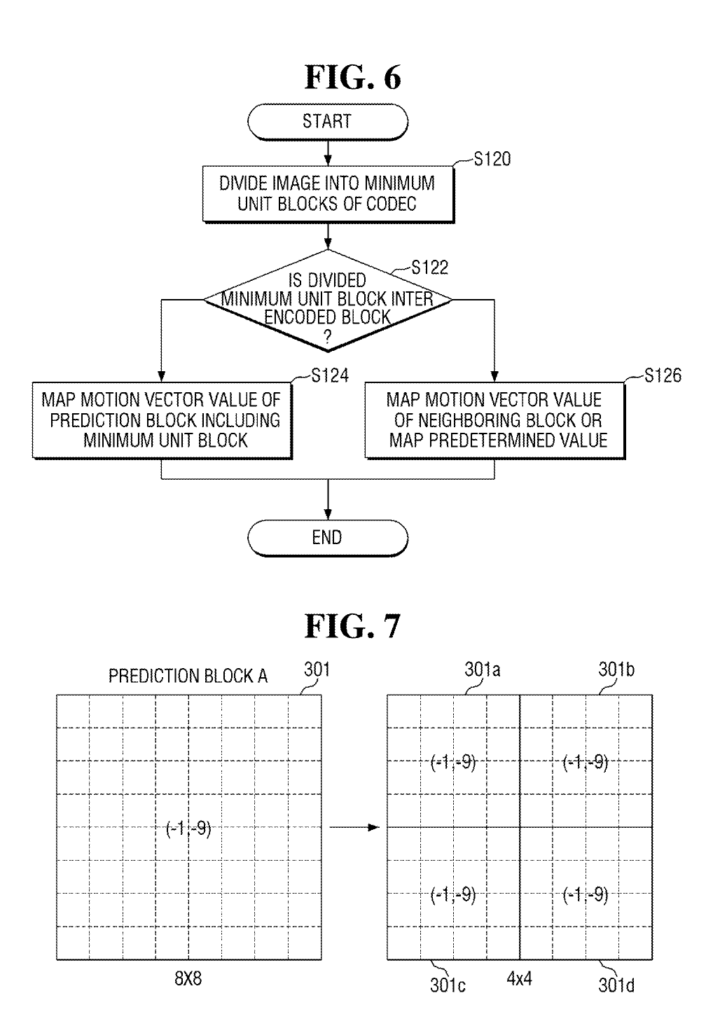

Hereinafter, referring to FIGS. 5 to 7, according to an exemplary embodiment of the present invention, a method for selecting an image when a motion vector value among the codec metadata information is used will be described. FIG. 5 is a flowchart of a method for selecting an image using a motion vector value with reference to some exemplary embodiments of the present invention and FIG. 6 is a flowchart of a method for mapping a motion vector value with reference to some exemplary embodiments of the present invention. Further, FIG. 7 is an exemplary diagram for describing a process of calculating a quality measurement value using a motion vector value with reference to some exemplary embodiments of the present invention.

A case where any one of the first codec metadata information and the second codec metadata information is set to the motion vector value is assumed. In this case, the quality measurement value of the motion vector value may be calculated through a process given below.

When the image selection apparatus 100 receives the image bitstream (S100), the image selection apparatus 100 may acquire the motion vector value of the image from the received bitstream (S110). The motion vector value may indicate a prediction block unit motion vector value including one frame of the image.

When the motion vector value is acquired, the image selection apparatus 100 may divide a decoded image into minimum unit blocks of the codec (S120) and map the acquired motion vector value for each minimum unit block (S130).

In step S120, a minimum unit of the codec may be, for example, 4×4. Encoding and decoding through the codec may be performed by the unit of the block of the image and encoding and decoding may be performed by the unit of different blocks including 4×4, 8×8, 16×16, 64×64, and the like according to a type of the codec and a set encoding method. Accordingly, the unit of the prediction block may vary depending on the type of the codec.

Since the value of the motion vector value is obtained by the unit of the prediction block, the image selection apparatus 100 may divide the image into the minimum unit block of the codec in order to uniformly compare qualities of images having different unit block sizes through the motion vector value. The image selection apparatus 100 maps the corresponding motion vector value for each divided minimum unit block to generate a uniformly sampled motion vector value field. The corresponding process is described in detail through FIGS. 6 and 7.

When the uniformly sampled motion vector value field is generated, the image selection apparatus 100 may calculate a motion vector value quality measurement value based on an absolute value of the motion vector value mapped to each minimum unit block included in the image (S140). When the motion vector value quality measurement value is calculated, the image selection apparatus 100 may calculate the quality score of the image by using the calculated motion vector value quality measurement value (S150) and select a predetermined number of images based on the calculated quality information of the image (S160).

Meanwhile, the process of mapping the motion vector value corresponding to the minimum unit block is described below through FIG. 6. The image selection apparatus 100 may divide the image into the minimum unit block of the codec (S120) and determine whether the block is an inter encoded block (S122).

A scheme of compressing the frame in the encoding unit of the codec includes an intra encoding scheme and an inter encoding scheme. The intra encoding is a spatial compression scheme that removes redundant information in one frame. As such, in the case of the intra encoding, even though the encoding process is performed in the encoding unit of the image pickup apparatus 50, the motion vector value information is not generated.

The inter encoding is a temporal compression scheme that removes the redundant information between different image frames and the encoded frame is referred to as an inter frame. In general, one inter frame exists per second or per two seconds.

In step S122, the image selection apparatus 100 may determine whether each minimum unit block of the image is the inter encoded block. When the minimum unit block is the inter encoded block, the image selection apparatus 100 may map the motion vector value of the prediction block including the minimum unit block to the motion vector value of the minimum unit block (S124).

On the contrary, when the minimum unit block is the intra encoded block, the motion vector value does not exist, and as a result, a replacement value to be mapped to the minimum unit block is required in addition to the motion vector value. In this case, in the image selection apparatus 100, the replacement value to be mapped to the minimum unit block may be previously set.

In general, a predetermined block in the image has a high correlation with neighboring blocks neighboring to the block. Accordingly, the replacement value may be generated by using the motion vector values of the inter encoded blocks among the neighboring blocks in order to generate the motion vector value which does not exist with respect to the intra encoded block. In this case, the image selection apparatus 100 senses that the image is the image including the intra encoded block and automatically extracts the motion vector value of the neighboring block of the intra encoded block to map the extracted motion vector value to the intra encoded block.

Alternatively, the image selection apparatus 100, a predetermined value may be used as the replacement value. For example, when a blurred image is encoded, inter prediction accuracy deteriorates, and as a result, there are a lot of cases in which the intra encoding is performed with the blurred image. Accordingly, it is assumed that there is a high possibility that the image including the intra encoded block will be the blurred image, a predetermined value is used as the replacement value to be used by the image selection apparatus 100.

In this case, the image selection apparatus 100 may sense that the image is the image including the intra encoded block and automatically map the replacement value to the intra encoded block. The predetermined value may be a value which is experimentally determined so as to have a low quality measurement value.

Referring to FIG. 7, a process of mapping the motion vector value and calculating the motion vector value quality measurement value when the minimum unit block is the inter encoded block is described as an example. In the example, it is assumed that the unit of the prediction block is 8×8 and the minimum block unit is 4×4. There is a case where the motion vector value of prediction block A 301 having a size of 8×8 is acquired as (−1, −9), and −1 indicates an x component of the prediction block unit motion vector value and −9 indicates a y component of the prediction block unit motion vector value.

Since 8×8 is not the minimum unit block, the prediction block A 301 is divided into 4×4 which is the minimum unit block. The motion vector value (−1, −9) of the prediction block A 301 including each block is mapped to respective blocks 301a, 301b, 301c, and 301d divided by the minimum unit.

When the mapping process is completed, the quality measurement value may be calculated. It may be evaluated that the absolute value of the motion vector value is larger, the quality of the image is lower and it may be determined that as the absolute value of the motion vector value is larger, a motion of the object in the image will be larger and the quality is lower. The absolute value of the motion vector value and the motion vector value quality measurement value have an inverse proportional relationship.

The image selection apparatus 100 may use a motion vector value quality measurement equation Fₘᵥ given below in order to measure the quality of the image by using the motion vector value.

$${F}_{MV} = - \frac{1}{N} \sum ( {MV ( i )}_{x}^{2} + {MV ( i )}_{y}^{2} ) , \\ ( i ∈ Minimum unit block in image )$$

Fₘᵥ represents an example of a quality measurement equation including the inverse proportional relationship of the absolute value of the motion vector value and the quality. N represents the number of unit blocks included in the image, MV(i)ₓ represents the x component of the motion vector value of an i-th unit block in the image, and MV(i)_{y} represents the y component of the motion vector value of the i-th unit block in the image.

When the quality measurement value of the block A 301 is obtained through the motion vector value quality measurement equation Fₘᵥ, the quality measurement value may be calculated as shown in F_{MV}=−¼((−1²+−9²)+(−1²+−9²)+(−1²+−9²)+(−1²+−9²))=82. The calculated 82 points may be used as the quality measurement value of the block A 301 and the calculated motion vector value quality measurement value is normalized to use the normalized value as the quality measurement value. The latter normalized quality measurement value may be used when the quality score of the image is calculated by using the quality measurement value of other codec metadata information together.

Since the image is constituted by a plurality of blocks, when the motion vector value quality measurement equation Fₘᵥ is applied to all blocks included in the image, the motion vector value quality measurement value for the image may be calculated.

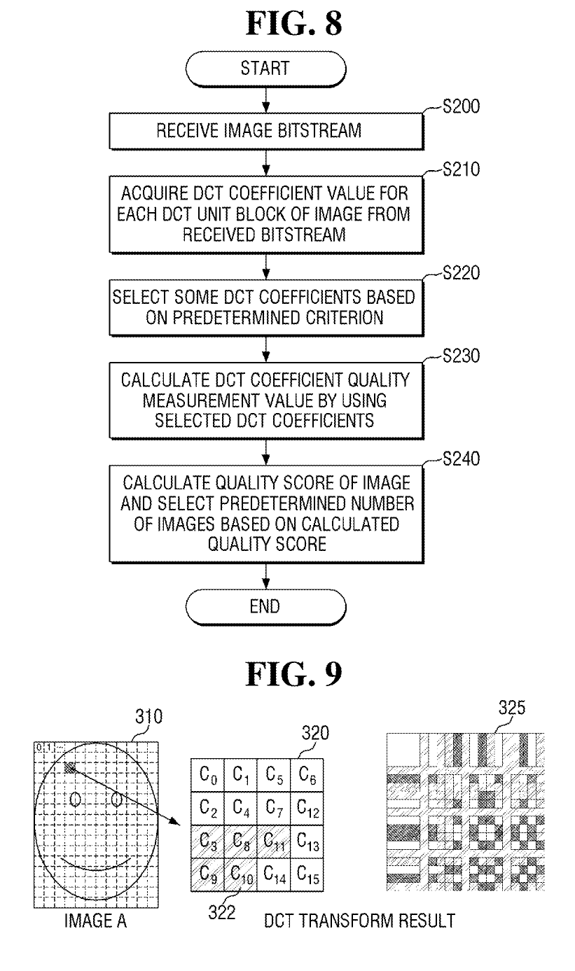

Hereinafter, referring to FIGS. 8 and 9, according to an exemplary embodiment of the present invention, the method for selecting the image when the DCT coefficient value among the codec metadata information is used will be described.

FIG. 8 is a flowchart of a method for selecting an image using a DCT coefficient value with reference to some exemplary embodiments of the present invention and FIG. 9 is an exemplary diagram for describing a process of calculating a quality measurement value using a DCT coefficient value with reference to some exemplary embodiments of the present invention.

A case where any one of the first codec metadata information and the second codec metadata information described above through FIGS. 3 and 4 is set to the DCT coefficient value is assumed. In this case, a DCT coefficient value quality measurement value may be calculated through a process given below.

When the image selection apparatus 100 receives the image bitstream (S200), the image selection apparatus 100 may acquire the DCT coefficient value for each DCT unit block of the image (S210). The image selection apparatus 100 may select some DCT coefficient values based on a predetermined criterion among the acquired DCT coefficient values (S220) and calculate a DCT coefficient value quality measurement value by suing the selected DCT coefficient value (S230). The image selection apparatus 100 may calculate the quality score of the image by using the DCT coefficient value quality measurement value and select a predetermined number of images based on the calculated quality score (S240).

Discrete cosine transform (DCT) is described. When the image is DCT-transformed, the corresponding image is transformed into a frequency domain from a spatial domain. A lower frequency domain in the frequency domain is component that may primarily show an overall image and intermediate frequency and high frequency components correspond to an edge component in the image or a component showing noise.

In step S220, the predetermined criterion is a selection criterion of the DCT coefficient value that allows the user to well identify a type of the object required for the object recognition. For example, the criterion to primarily select the intermediate and high frequency components rather than the low frequency domain may correspond to the predetermined criterion. In this case, each of the intermediate and high frequency components may have a frequency size within a predetermined range.

In addition, the DCT coefficient value may be selected in consideration of an association between the DCT coefficient value component and the object recognition result. For example, when face recognition is performed in an environment where a person looks at a camera frontally, the image of the person is picked up with a relatively constant size and angle through the camera, and as a result, when the DCT coefficient value of a predetermined part is extracted, it can be seen through data accumulation that the object recognition is successfully performed. As such, the DCT coefficient value may be experimentally selected and an experimentally acquired result may be set as the criterion of the DCT selection.

Further, the DCT coefficient value may be selected differently according to an installation environment of the image pickup apparatus 50 and set to be automatically changed as data including the object recognition result, and the like are accumulated.

Hereinafter, a process of selecting the DCT coefficient value and calculating a vector quality measurement value will be described as an example with reference to FIG. 9. The process is an example of the case where the DCT unit block size is 4×4.

FIG. 9 illustrates image A 310 of which the quality is to be measured and results 320 and 325 acquired by DCT-transforming the image A 310 by the unit of 4×4 and illustrates, for example, a case where C₃, C₈, C₉, C₁₀, and C₁₁ 322 among the DCT coefficient values of the intermediate and high frequency components are selected.

The DCT coefficient value and the DCT coefficient value quality measurement value have a proportional relationship in which the quality is evaluated to be higher as the absolute value of the DCT coefficient value is larger. A DCT coefficient value quality measurement equation F_{c} may be set as below.

$${F}_{C} = \frac{1}{N} \sum \sum \vert {C}_{j} ( i ) \vert - \\ ( i ∈ DCT unit block in image , j ∈ Selected DCT coefficient )$$

F_{c} represents an example of the quality measurement equation including the proportional relationship of the absolute value of the DCT coefficient value and the quality. N represents the number of DCT unit blocks included in the image and C₁((l) represents a j-th coefficient of an i-th DCT unit block in the image.

The image selection apparatus 100 may use the equation in order to measure the quality of the image by using the DCT coefficient value.

When the quality measurement value of some block 320 of the image A 310 is obtained through the DCT coefficient value quality measurement equation F_{c}, the quality measurement value may be calculated as shown in

$${F}_{C} = \frac{1}{1} {\sum }_{i}^{ } ( \vert {C}_{3} ( i ) \vert + \vert {C}_{8} ( i ) \vert + \vert {C}_{9} ( i ) \vert + \vert {C}_{10} ( i ) \vert + \vert {C}_{11} ( i ) \vert ) .$$

The calculated F_{c} value may be used as the quality measurement value and the calculated DCT coefficient value quality measurement value is normalized to use the normalized value as the quality measurement value. The latter quality measurement value may be used when the quality score of the image is calculated by using the quality measurement value of other codec metadata information together.

The quality score of the image A 310 may be calculated through the F_{c} calculation process with respect to all DCT unit blocks included in the image A 310.

Referring to FIG. 10, according to an exemplary embodiment of the present invention, when the first codec metadata information is set to the motion vector and the second codec metadata information is set to the DCT coefficient value, a method for selecting an image using two codec metadata information will be described. FIG. 10 is a flowchart of a method for selecting an image using a motion vector value and a DCT coefficient value as codec metadata information according to yet another exemplary embodiment of the present invention.

When the image selection apparatus 100 receives the image bitstream (S300), the image selection apparatus 100 may acquire the motion vector value of the image and the DCT coefficient value of the image from the bitstream (S310). The motion vector value quality measurement value and the DCT coefficient value quality measurement value may be calculated by the aforementioned method by using the acquired motion vector value and the acquired DCT coefficient value (S320 and S330).

In order to calculate the quality score by using the quality measurement values, the image selection apparatus 100 may normalize the calculated motion vector value quality measurement value and the calculated DCT coefficient value quality measurement value (S340). The image selection apparatus 100 applies a predetermined weight to the normalized motion vector value quality measurement value and the normalized DCT coefficient value quality measurement value to calculate the quality score of the image (S350). Further, the image selection apparatus 100 may select a predetermined number of images based on the quality score of the image (S360).

A quality score calculation equation of the image, which is used by the image selection apparatus 100 in step S350 may be set as shown in Score=w_{MV}·F′_{MV}+w_{C}·F′_{C}. F′_{MV} and F′_{C} represent the normalized motion vector value quality measurement value and the normalized DCT quality measurement value, respectively.

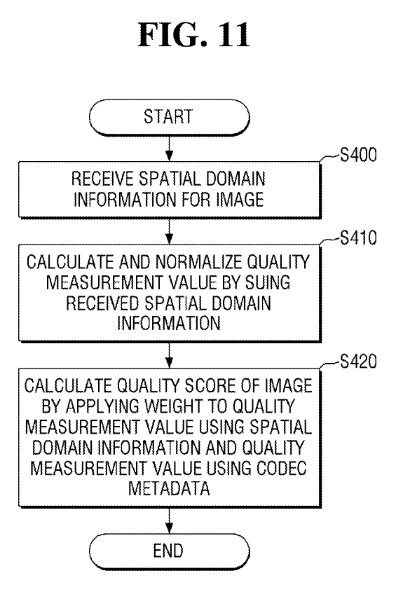

Meanwhile, spatial domain information for the image may be further used in addition to the codec metadata information in measuring the quality of the image. The spatial domain information as information which may be obtained in a spatial domain in which the image is picked up may include a difference in head pose, a degree of illumination change, sharpness, a contrast, an opening degree of an eye, a size of a face domain, and the like. Hereinafter, a method for measuring the quality of the image using the spatial domain information and the codec metadata information will be described with reference to FIG. 11. FIG. 11 is a flowchart of a method for measuring a quality of an image using spatial domain information according to still yet another exemplary embodiment of the present invention.

Referring to FIG. 11, the image selection apparatus 100 may acquire the spatial domain information for the image bitstream from the image pickup apparatus 50 (S400). The image selection apparatus 100 may calculate the quality measurement value of the image by using the acquired spatial domain information and normalize the calculated quality measurement value (S410).

The image selection apparatus 100 applies a predetermined weight to the quality measurement value of the image by using the normalized spatial domain information, and the first quality measurement value and the second quality measurement value calculated and normalized by using the codec metadata information to calculate the quality score of the image (S420).

In step S420, when an image score is intended to be calculated by using n quality measurement values obtained in the spatial domain, an image score calculation equation may be configured as below. When the motion vector value and the DCT coefficient value are set as the codec metadata information as illustrated in FIG. 10, the quality score of the image may be calculated as shown in Score=w_{MV}·F′_{MV}+w_{C}·F′_{C}+w₁·F′₁+w₂·F′₂+ . . . +wₙ·F′ₙ. F′₁,F′₂, . . . , F′ₙ represent n normalized quality measurement values obtained in the spatial domain and w₁,w₂, . . . , wₙ represent weights applied to the respective quality measurement values.

The image selection apparatus 100 may calculate a final score for the image by using the calculation equation for the image score.

The spatial domain information may be used when the face recognition is used through the camera installed in a bus. When the quality of the image is measured by combining pose information of a person who rides on the bus, accuracy of the face recognition may increase.

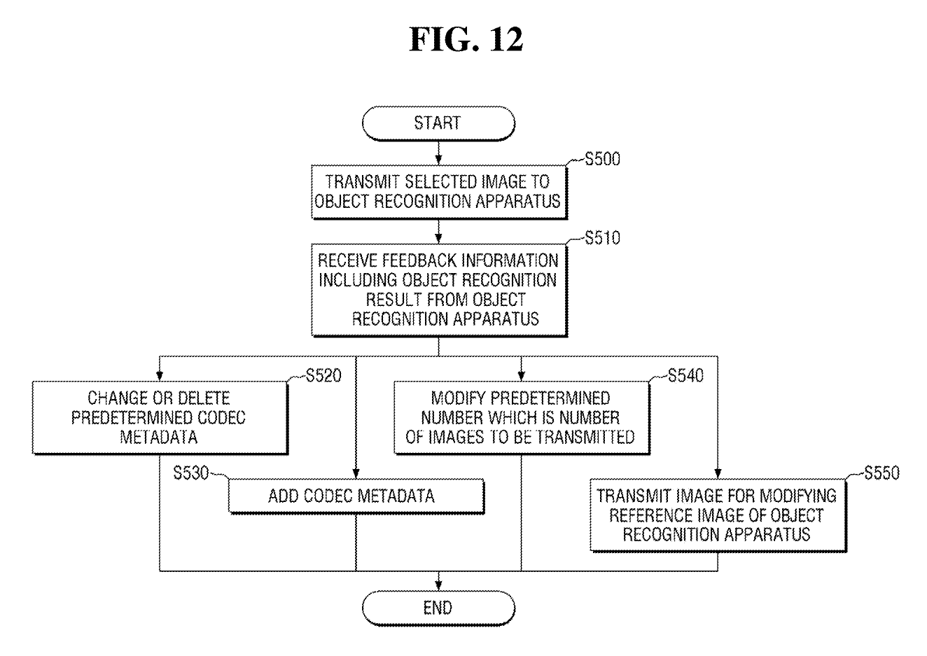

According to some exemplary embodiments of the present invention, when the quality score of the image is calculated, the image selection apparatus 100 may selects a predetermined number of images according to the quality score and transmit the selected images to the object recognition apparatus 200 and receive feedback information for the transmitted images and this will be described below with reference to FIG. 12. FIG. 12 is a flowchart of a method for selecting an image using feedback information acquired from an object recognition apparatus according to still yet another exemplary embodiment of the present invention.

When the image selection apparatus 100 transmits the selected image to the object recognition apparatus 200 (S500), the image selection apparatus 100 may receive the feedback information including the object recognition result from the object recognition apparatus (S510). When the image selection apparatus 100 and the object recognition apparatus 200 are integrated and implemented, the image selection unit of the object recognition apparatus may provide the selected image to the object recognition unit and receive feedback from the object recognition unit.

The feedback information may include success or failure of the object recognition result, a time required for the object recognition, a score parameter of the selected image, and the like. The image selection apparatus may change predetermined codec metadata information to another codec metadata information or delete the predetermined codec metadata information (S520) or add another codec metadata (S520), based on the feedback information. For example, when the motion vector value is set as the first codec metadata information and the DCT coefficient value is set as the second codec metadata information, the image selection apparatus 100 may change the second codec metadata information to block sizes divided from the DCT coefficient value or delete the DCT coefficient value from quality measurement items. Further, the image selection apparatus 100 may add a division block size, a quantization parameter, or a bit rate as the quality measurement items in addition to the motion vector value and the DCT coefficient value.

The codec metadata information which may be selected as the criterion of the quality measurement may include the motion vector value, the discrete cosine transform (DCT) coefficient value, the block division size, the quantization parameter, the bit rate, and the like.

As the block division size is smaller, the quality measurement value may be evaluated to be higher. When the image is compressed, in a part where the change is small, such as a background, a compression rate is increased by increasing the block division size and since a part including the object is an important part of the image, the compression rate is decreased so that the part includes more information by decreasing the block division size. Since the blurred image is a smoothed image, a change between pixels is small, and as a result, even though the blurred image includes the part including the object, when the image is compressed, the block division size is determined to be large. Accordingly, it may be predicted that as the block division size is smaller, the quality of the image is higher.

As the quantization parameter (QP) is smaller, the quality measurement value may be evaluated to be larger. There is a compression method that adaptively uses the quantization parameter for each frame or for each block in order to enhance compression efficiency. A quantization process is performed after the DCT transform and the image is compressed by leaving the low frequency component and mainly making the high frequency component be zero through the quantization process. This is to compress information of a part which exerts a comparatively small influence on the image quality of the image, such as the background. As the coefficient parameter is set to be low, the compression rate becomes low and there is a high possibility that the quantization parameter will be set to be low in the block in which the object in the image is positioned. There is a high possibility that the blurred image will be misjudged as a frame in which only the background without the object is picked up because a change in pixel value is small and a block division size is determined to be large at the time of compression, and as a result, there is a high possibility that a quantization coefficient will be largely allocated. Accordingly, when adaptive quantization based compression is performed, the quantization parameter and the quality measurement value may have the inverse proportional relationship.

Further, as the bit rate is larger, the quality measurement value may be evaluated to be higher. The reason is that a frame to which the large bit rate is allocated will be a frame including a clear object having a lot of information to be encoded in the adaptive quantization based compression. In the case of the blurred image, since the change of the pixel value is small and the block division size is large, codec metadata to be compressed is small, and as a result, the quantity of bits consumed for frame encoding is small.

When the quality measurement item is added, more specifically, the image selection apparatus 100 may acquire predetermined third codec metadata information based on the feedback information. Further, the image selection apparatus 100 may calculate a third quality measurement value using the acquired third codec metadata information. Next, the image selection apparatus 100 normalizes the calculated third quality measurement value and applies a predetermined weight to the existing normalized first quality measurement value and the existing normalized second quality measurement value and the normalized third quality measurement value to calculate the quality information of the image.

In another exemplary embodiment, the image selection apparatus 100 may change for at least one information of predetermined first codec metadata information and second codec metadata information based on the feedback information.

Further, the image selection apparatus 100 may modify the predetermined number to the number of images to be transmitted based on the feedback information (S530) or transmit the image to the object recognition apparatus 200 so as to modify the reference image of the object recognition apparatus (S550).

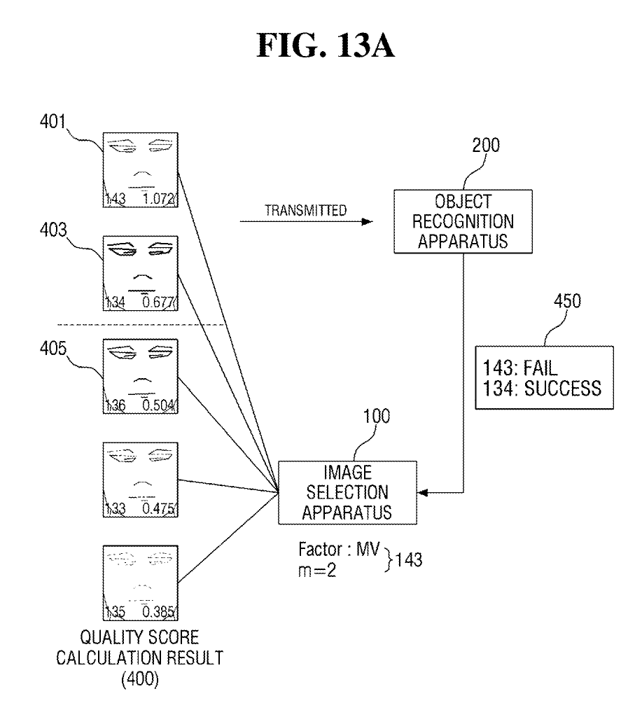

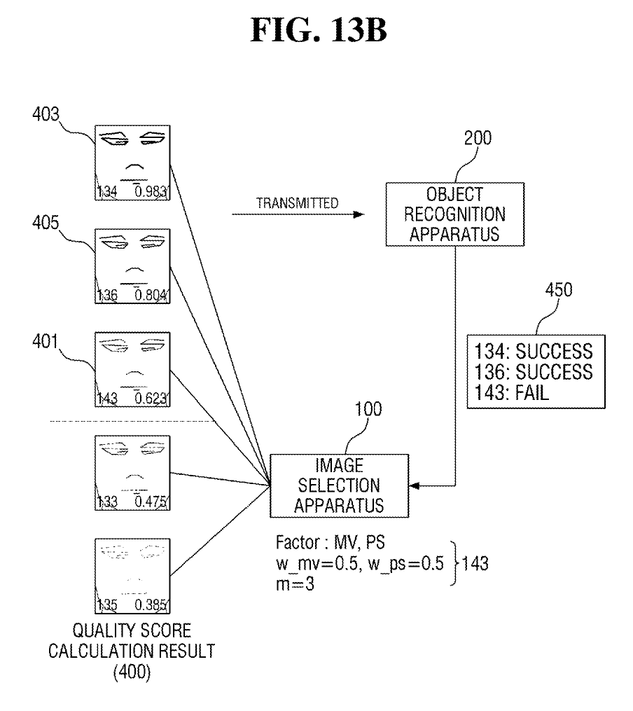

An example of a process in which the feedback is performed is described through FIGS. 13A and 13B. FIGS. 13A and 13B are examples for describing aspects of using feedback information of an apparatus for selecting an image with reference to some exemplary embodiments of the present invention.

Hereinafter, the face recognition will be described as one example of the object recognition.

A quality score calculation result 400 for a plurality of images is illustrated in FIG. 13A. A number disclosed at a lower left end of the image represents the number of the image and a numerical figure disclosed at a right side of the image represents the quality score.

The quality calculation information 143 may include information required for calculating the quality score of the image and may be previously set and stored in the image selection apparatus 100. The quality calculation information 143 illustrated in FIG. 13A represents that the motion vector value is set as current codec metadata information and the number of images to be transmitted is set to two.

The image selection apparatus 100 may calculate the quality score of the image by using the motion vector value and sort the plurality of images as the quality score calculation result 400 base on the quality score. The image selection apparatus 100 may select a predetermined number, that is, two images 401 and 403 having the highest score in the sorted quality score calculation result 400 and transmit the selected images 401 and 403 to the object recognition apparatus 200. When the object recognition apparatus 200 receives the image, the object recognition apparatus 200 compares the received image and a registration image pre-stored in the object recognition apparatus 200 to perform the object recognition.

As a result of performing the object recognition, when the object recognition is unsuccessful with respect to image #143 401 and the object recognition is successful with respect to image #134 403, the object recognition apparatus 200 may transmit feedback information 450 including the result to the image selection apparatus 100.

Since this case is a case where the object recognition is unsuccessful with respect to image #143 401 in which the quality score measured by a predetermined quality measurement criterion is highest, the quality measurement criterion needs to be modified by reflecting the feedback information. FIG. 13B illustrates an example in which the quality measurement criterion is modified by reflecting the feedback information.

The image selection apparatus 100 may modify the quality score calculation information 143 by reflecting the feedback information received from the object recognition apparatus 200. Referring to the quality calculation information 143, it can be seen that a block division size (PS) is added to the codec metadata information, a weight to be applied to each factor is modified to 0.5, and the number of images to be transmitted is modified to three.

The image selection apparatus 100 may measure the image quality and select the image by using the modified quality calculation information 143. It can be verified that the quality measurement result is different through the quality score calculation result 400.

Referring to the quality score calculation result 400 illustrated in FIG. 13A, top three images in terms of the quality score are image #143 401, image #134 403, and image #136 405, but referring to the quality score calculation result 400 illustrated in FIG. 13B, top three images in terms of the quality score are image #134 403, image #136 405, and image #143 401. Further, the quality scores calculated for the respective images are also different from each other.

Further, since the number of images to be transmitted is changed to three, the image selection apparatus 100 transmits three images of image #134 403, image #136 405, and image #143 401 to the object recognition apparatus 200. The object recognition apparatus 200 may perform the object recognition with respect to the received image and transmit the feedback information including the result to the image selection apparatus 100 again. The image selection apparatus 100 transmits more images to receive the feedback with respect to more images and examine the modified quality measurement method through the received feedback.

Referring to the feedback information 450, it can be seen that the object recognition is successful with respect to image #134 403 and the object recognition may also be successful with respect to #136 405 which is not previously transmitted. As a result, it can be seen that the accuracy of the quality measurement is improved and the quality calculation information 143 is more appropriately changed.

Further, although not illustrated through the drawings, the image selection apparatus 100 reflects the feedback information to modify the reference image of the object recognition apparatus 200. The reference image means a registered image of the object, which becomes the criterion of the object recognition.

As time goes on, the object is changed, but since a separate update process that registers the image by separately picking up the object needs to be performed in order to change the reference image in the existing object recognition apparatus 200, it is difficult to maintain the reference image by reflecting the change of the object.

However, according to the exemplary embodiment of the present invention, the object recognition apparatus 200 may transmit to the image selection apparatus 100 feedback information including the quality score, a registration date, and an image generation date of the reference image and the image selection apparatus 200 may determine whether updating the reference image is required based on the feedback information associated with the reference image.

For example, the image selection apparatus 100 may compare the highest quality score among the quality scores of the images included in the quality score calculation result 400 and the quality score of the acquired reference image. As a comparison result, when the quality score of the reference image is lower than the highest quality score, the reference image may be replaced with the image having the highest quality score.

The image selection apparatus 100 may transmit to the object recognition apparatus 200 a control message to replace the reference image of the object recognition apparatus 200 with the image having the highest quality score. For example, when a predetermined period elapses after the reference image is updated, it may be determined whether updating the reference image is required according to a predetermined criterion including a case where a predetermined period elapses from the image generation date, and the like. When it is determined that updating the reference image is required, the image selection apparatus 100 may transmit the image the object recognition apparatus 200 so as to update the reference image to the image having the highest quality score.

Since the reference image becomes a criterion to determine whether the object recognition is performed in the object recognition, using a clear reference image exerts a large influence on determining whether the recognition is performed. The quality score calculation result 400 of the image selection apparatus 100 is used for selecting the reference image to enhance performance of the object recognition.

As described above, according to the present invention, a quality of an image is measured by using codec metadata information which is information on an image already analyzed through an encoding process to achieve an effect that image quality measurement having low complexity is available.

According to the present invention, an image selection apparatus can be provided, which automatically increases a quality measurement item on the codec metadata information used for the quality measurement according to an acquisition environment of the image. As a result, it is advantageous in that the image selection apparatus can perform stable image quality measurement even in a change of the image acquisition environment.

According to the present invention, there is an effect that an image selection apparatus is provided, which can enhance accuracy of object recognition irrespective of functional enhancement of the object recognition apparatus by determining an image which becomes a target of the object recognition by using an object recognition result from the object recognition apparatus as feedback information.

According to the present invention, there is an effect that the image of an object can be automatically updated, which is registered in the object recognition apparatus for the object recognition.

The effects of the present invention are not limited by the foregoing, and other various effects are anticipated herein.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

While the present invention has been particularly illustrated and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A method for selecting an image for object recognition, the method comprising:
receiving an image bitstream representing a plurality of images that are photographed continuously;
acquiring predetermined first codec metadata information among codec metadata information from the received image bitstream;
calculating a first quality measurement value using the acquired first codec metadata information;
calculating a quality score of each image of the plurality of images by using the calculated first quality measurement value; and
selecting a predetermined number of images from the plurality of images based on the calculated quality score of said each image of the plurality of images.

2. The method of claim 1, further comprising:
acquiring predetermined second codec metadata information, which is different from the predetermined first codec metadata information, among the codec metadata information from the received image bitstream;
calculating a second quality measurement value using the acquired predetermined second codec metadata information; and
normalizing the calculated first quality measurement value and the calculated second quality measurement value with respect to each other,
wherein the quality score of said each image is calculated by applying a predetermined weight value to the normalized first quality measurement value and the normalized second quality measurement value.

3. The method of claim 1, further comprising:
extracting a region of interest (ROI) from the image bitstream,
wherein the first quality measurement value is calculated with respect to the extracted ROI.

4. The method of claim 2, further comprising:
acquiring spatial domain information for the received image bitstream; and
calculating and normalizing a third quality measurement value for the spatial domain information,
wherein the quality score of said each image is calculated by applying a predetermined weight value to the normalized third quality measurement value, the normalized first quality measurement value, and the normalized second quality measurement value.

5. The method of claim 1, further comprising:
transmitting the selected predetermined number of images to an object recognition apparatus; and
receiving feedback information including an object recognition result from the object recognition apparatus,
wherein the calculating the quality score of the each image comprises changing a weight value associated with the predetermined first codec metadata information.

6. The method of claim 2, further comprising:
transmitting the selected predetermined number of images to an object recognition apparatus; and
receiving feedback information including an object recognition result from the object recognition apparatus,
wherein the calculating the quality score of the image comprises:
acquiring predetermined third codec metadata information among the codec metadata information based on the feedback information,
calculating a third quality measurement value using the acquired predetermined third codec metadata information,
normalizing the calculated third quality measurement value, and
calculating the quality score of the each image by applying a predetermined weight value to the normalized first quality measurement value, the normalized second quality measurement value, and the normalized third quality measurement value.

7. The method of claim 1, further comprising:
transmitting the selected predetermined number of images and the quality score calculated with respect to the selected predetermined number of images to an object recognition apparatus;
receiving feedback information including an object recognition result from the object recognition apparatus;
acquiring the quality score of a reference image pre-registered in the object recognition apparatus from the received feedback information; and
transmitting to the object recognition apparatus a control message for replacing the reference image with an image having a highest quality score among the selected predetermined number of images.

8. The method of claim 1, wherein the first codec metadata information comprises at least one of a motion vector value, a discrete cosine transform (DCT) coefficient value as a transform coefficient in a frequency domain, a block division size, a quantization parameter, and a bit rate.

9. The method of claim 1, wherein, when the first codec metadata information is set to a motion vector value, the calculating the first quality measurement value comprises:
dividing the each image into minimum unit blocks of a codec,
mapping the motion vector value for each divided minimum unit block of the minimum unit blocks, and
calculating the first quality measurement value based on an absolute value of the motion vector value mapped to the each minimum unit block included in the each image.

10. The method of claim 9, wherein the mapping the motion vector value for the each minimum unit block comprises:
mapping the motion vector value of a prediction block including the each divided minimum unit block when the each divided minimum unit block is an inter encoded block, and
mapping one of the motion vector value of a neighboring block and a predetermined value when the each divided minimum unit block is an intra encoded block.

11. The method of claim 1, wherein, when the first codec metadata information is set to a DCT coefficient value, the calculating the first quality measurement value comprises:
acquiring DCT coefficient values, each DCT value of the acquired DCT coefficient values corresponding to each DCT unit block included in the each image,
selecting some DCT coefficient values among the acquired DCT coefficient values according to a predetermined criterion, and
calculating the first quality measurement value based on an absolute value of the selected DCT coefficient values.

12. The method of claim 11, wherein the predetermined criterion is to select, among the acquired DCT coefficient values, values that have at least one of (i) an intermediate frequency component within a predetermined range, and (ii) a high frequency component within the predetermined range.
